(19) United States
(12) Patent Application Publication
(10) Pub. No.: US 2004/0040460 A1
(43) Pub. Date: Mar. 4, 2004

(54) Method and device for coating printed products

(76) Inventors: Wolfgang Frei, Friedberg (DE); Andreas Ihme, Goldbach (DE); Thomas Walther, Freigericht (DE); Rainer Gebhardt, Muhlheim (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/362,783

(22) PCT Filed: Aug. 16, 2001
(86) PCT No.: PCT/EP01/09422

(30) Foreign Application Priority Data
Aug. 25, 2000 (DE) 100419348

(51) Int. Cl. B41F 23/04; H05H 1/24

(52) U.S. Cl. 101/487

(57) ABSTRACT

A method and apparatus for coating printed products, wherein the products are initially printed in at least one printing process and are provided with a layer that covers the printing ink on the printed product immediately thereafter in at least one coating process. According to the invention, a corona treatment device is arranged between the final printing station and a device for coating the printing products for subjecting the printing ink on the printing product to a corona treatment immediately after the printing process such that UV varnish can be directly applied onto the printing inks without the requirement of additional printing processes.

### FIELD OF THE INVENTION

The present invention relates generally to printing machines, and more particularly, to printing machines for printing printable material with a printing ink and thereafter coating the printed material.

The invention pertains to a method and a device for coating printed products according to the preambles of the respective independent claims.

### BACKGROUND OF THE INVENTION

Serial sheet-fed offset printing machines comprise a printing station consisting of an impression cylinder, a rubber blanket cylinder, and a plate cylinder for each color to be printed. One or more varnishing devices are arranged downstream of the printing stations for subsequently treating the multicolor printed sheets. In such machines, additional transfer modules in the form of extension sections or modules need to be provided between the printing stations and the individual varnishing devices such that the last ink or varnish layer applied is able to thoroughly dry and/or harden before the sheet is subjected to the next processing step. As a result, drying units that act appropriately upon the respective type of ink or varnish applied need to be provided in these extension modules.

Prints of a very high quality are obtained if a printed color image is covered with a high-gloss varnish layer. UV varnishes are used for achieving such a high gloss. If it is intended to apply such a UV varnish directly onto conventional printing inks, such as printing inks that contain oil, adhesion problems arise due to the different intensities of the intermolecular forces of the varnish and the ink. As a result, a UV varnish cannot be directly applied onto printing inks that contain oil without additional measures.

Heretofore, UV varnishes could only be applied onto printing inks containing oil after covering these printing inks with a primer. Hence, a priming layer that serves as a bonding agent initially had to be applied onto the last layer of printing ink, with the UV varnish layer subsequently being applied onto this priming layer.

If it is intended to apply a UV varnish layer onto printing inks containing oil in one production step, i.e., in-line, the printing machine needs to contain a first coating station for applying the primer and a second coating station for ultimately applying the UV varnish, in addition to the respective number of printing stations. A disadvantage of such an arrangement is that an additional coating station for applying the primer needs to be arranged upstream of the coating station for the UV varnish, and that an additional drying section needs to be arranged between these two coating stations. Accordingly, printing machines with this type of equipment are expensive.

Instead of printing the UV varnish over a primer previously applied onto the printing inks, it would be conceivable to provide the printed sheets with a primer coating immediately after the printing process, wherein the desired UV varnish is then applied in a second printing process, for example, on the same machine or on a special varnishing machine. Such a method requires corresponding logistics and time-consuming handling of the products to be printed. In addition, the total production time is prolonged because the products to be printed have to make two passes through the machine.

A device for removing a gaseous laminar boundary layer on a moving web is known from DE 195 25 453 A1. This device consists of a corona charging electrode that can be connected to a high-voltage source, as well as a corresponding counter electrode. The electrodes generate an electron stream perpendicular to the moving web which destroys the laminar boundary layer that moves together with the web and causes inferior drying properties of the printed material. Although this publication discloses measures that make it possible to improve the drying effect, varnish layers with unsuitable surface tension cannot be applied onto ink layers in this fashion.

The utilization of corona devices in printing machines also is known. In this case, the corona treatment serves, for example, to render foils printable. However, these devices are arranged at a specific location dictated by that specific use.

### OBJECTS AND SUMMARY OF THE INVENTION

It is an object of the present invention to provide a method and apparatus for applying UV varnish directly onto sheets printed with conventional printing inks without additional required printing processes.

Another object is to provide a method and apparatus as characterized above which can be efficiently carried out and controlled.

A further object is to provide an apparatus of the foregoing type which is relatively simple in construction and which lends itself to economical manufacture and usage.

In a method according to the invention, the ink layer formed by conventional printing inks-containing oil is subjected to a corona treatment immediately after the printing process at the last printing station is completed, such that charged carriers in the form of electrons temporarily charge the ink layer. Due to this charging of the ink layer, the intermolecular structure in the ink layer is changed such that the surface tension is altered positively with respect to adhesion of a UV varnish layer. Temporary adhesion of the UV varnish to the ink layer is achieved due to the charge carriers that are temporarily introduced into the top ink layer. As a result, a sheet with one or more ink layers of conventional printing ink can be directly provided with UV varnish layers without additional measures for improving the adhesion.

The method according to the invention makes it possible to obtain printed products that are coated with a UV varnish in one printing process that is carried out on a sheet-fed offset printing machine with one or more printing stations using conventional printing inks and a varnishing device arranged downstream of these printing stations. Preferably, the corona treatment [according to the invention] is carried out directly when the printed sheet is on the impression cylinder of the last printing station.

The apparatus for effecting the method according to the invention includes an electrode that extends transversely over the maximum format width of the printed material, with the electrode being connected to a high-voltage source and cooperating with a metallic surface that serves as the counter electrode and over which the sheet is transported. The metallic surface preferably is a printing machine cylinder, namely the impression cylinder.

According to one preferred embodiment of the invention, an electrode for effecting the corona treatment is associated with the impression cylinder of the last printing station in a sheet-fed offset printing machine having several printing stations and with a varnishing device being arranged downstream of the last printing station, wherein the electrode acts upon the ink layer by means of charged electron carriers.

According to the invention, the surface of the printing ink, including conventional printing inks containing oil, is activated, i.e., the critical surface tension is increased in such a way that a UV varnish can be applied directly over the printing ink without further processing. As indicated above, a corona treatment is carried out for this purpose between the printing station and the UV varnish coating station. The electrode is installed above the impression cylinder of the last printing station. The surface of the impression cylinder and the corona electrode are spaced apart by a few mm. The power of the corona treatment depends on the machine speed and is controlled accordingly. This requires a machine signal with regard to the sheet transport speed, which can be obtained in analog or digital form from the machine control or the control panel of the printing machine. Irradiation is interrupted whenever the printing cylinder channel passes the corona section. This requires a signal with regard to the angle of rotation of the corresponding impression cylinder of the printing station that carries the corresponding counter electrode. An analog and/or digital machine signal also can be utilized for this purpose.

In order to control the electrode for effecting the corona treatment, the electrode is connected to a controllable high-voltage source with an appropriate controller. The control of the high-voltage source receives a signal concerning the speed of the printing machine, as well as another signal concerning the machine angle, in particular, the angle of the corresponding impression cylinder. Instead of utilizing a machine angle, it would also be possible to evaluate a trigger signal, the length of which corresponds, for example, to the time of passage of the channel of the impression cylinder beneath the electrode.

Treatments by means of corona electrodes currently are performed to pretreat sheets to be printed. In this case, one utilizes the fact that the surface structure of the sheets can be altered such that superior ink absorption properties can be achieved.

Other objects and advantages of the invention will become apparent upon reading the following detailed description and upon reference to the drawings, in which:

### BRIEF DESCRIPTION OF THE DRAWINGS

FIG. 1 is a partially diagrammatic side elevation view of the final printing station of a printing machine having a coating device with the corona treatment system in accordance with the invention; and

FIG. 2 is a diagrammatic depiction of the control for the discharge from a corona treatment system of the illustrated printing machine.

While the invention is susceptible of various modifications and alternative constructions, a certain illustrated embodiment thereof has been shown in the drawings and will be described below in detail. It should be understood, however, that there is no intention to limit the invention to the specific form disclosed, but on the contrary, the intention is to cover all modifications, alternative constructions and equivalents falling within the spirit and scope of the invention.

### DETAILED DESCRIPTION OF THE PREFERRED EMBODIMENT

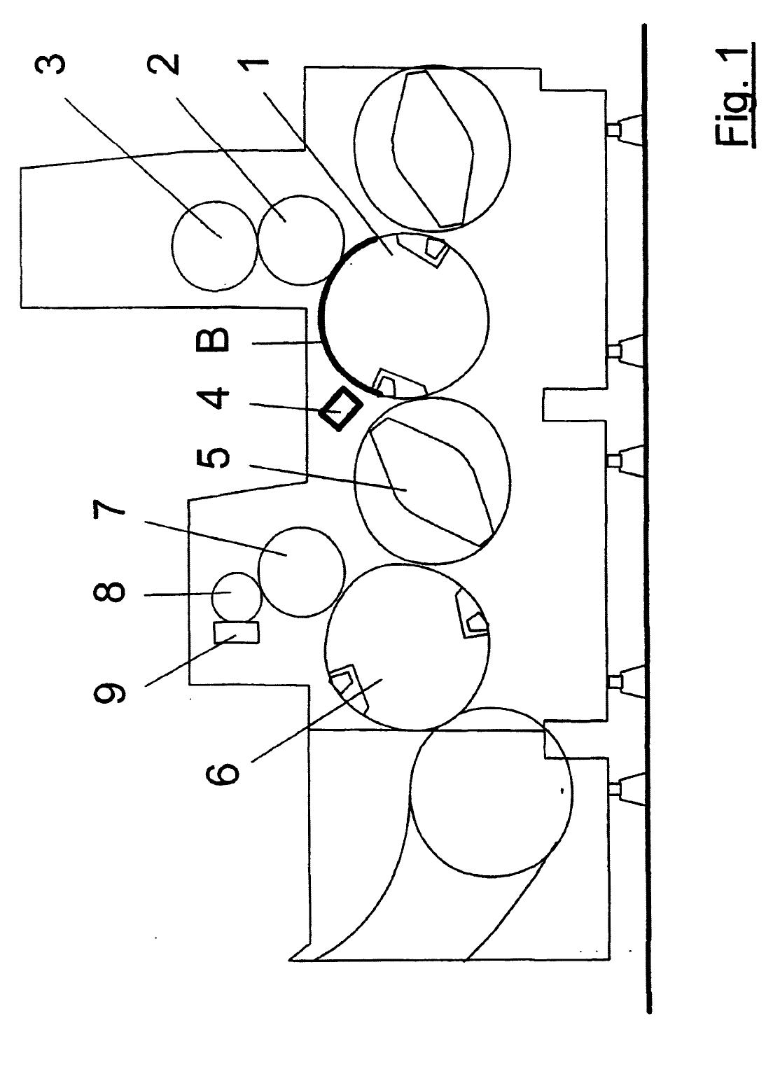

Referring now more particularly to FIG. 1 of the drawings, there is shown an illustrative sheet-fed offset printing machine having a coating device in accordance with the present invention. More particularly, FIG. 1 depicts the final printing station of the printing machine, which includes a rubber blanket cylinder 2 and a plate cylinder 3 that cooperate with an impression cylinder 1 in a conventional manner. The impression cylinder 1 in this case rotates in a counterclockwise direction. As is well understood by a person skilled in the art, sheet or other printable material processed through the printing machine, including the final printing station, is printed with printing ink, including conventional printing inks containing oil.

In accordance with the invention, a device for applying corona treatment to the printing ink on the sheet material following the final printing process is provided for conditioning the printing ink such that it will accept a coating layer in an immediately downstream coating device or station without further processing of the sheet material. To this end, in the illustrated embodiment, a rod-shaped electrode 4 is provided for effecting a corona treatment to the printing ink on the sheet material directly as it is leaving the final printing station. The illustrated electrode 4 is arranged a predetermined distance from the surface of the impression cylinder 1 behind the printing gap or nip between the impression cylinder 1 and the rubber blanket cylinder 2, as viewed in the sheet transport direction. Sheet material being transported through the small space or gap between the electrode 4 and the surface of the impression cylinder 1 are acted upon by charged carriers or electrons emitted by reason of the electrode. The printing ink on the sheet material is conditioned by the corona treatment as it is being transferred about the impression cylinder 1, while held in position by appropriate gripping devices associated with the impression cylinder 1.

In carrying out the invention, the sheet material printed in the final printing station of the printing machine and subjected to the corona treatment emitted by the electrode 4 is transferred to the impression cylinder 6 of an immediately downstream varnishing station. A transfer cylinder 5 in this case transfers the sheet material to the varnishing station. No further drying or processing of the printing sheet is required between the final printing station and the coating station. It will be understood by one skilled in the art that the impression cylinder 1 of the last printing station and the impression cylinder 6 of the varnishing station each have appropriate gripping devices in respective channels of the cylinders. The varnishing station in this case further includes a conventional form cylinder 7 and application roll 8 in the form of a screen roll that cooperates with a doctor blade system 9 associated with the impression cylinder 6.

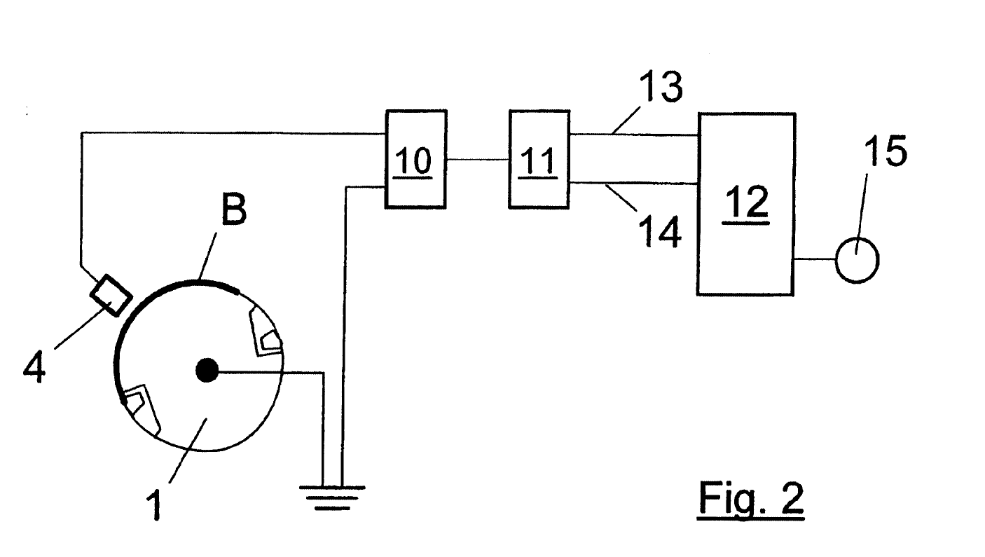

The components provided for controlling operation of the electrode according to the invention are shown in FIG. 2. The electrode 4 that extends over the format width of the impression cylinder 1, as well as the impression cylinder 1 that serves as the counter electrode and carries the sheet B, are connected to a high-voltage source 10 such that a high voltage which can be controlled as to duration and intensity can be applied to the electrode 4 situated opposite the surface the cylinder 1. For this purpose, a signal connection is provided between the high-voltage source 10 and an appropriate control 11, wherein signals from a machine control 12 can be fed to said control 11 via lines 13, 14. A signal concerning the printing speed (rotational speed of the printing machine) and the passage of the channel of the impression cylinder 1 (beneath the electrode 4) are forwarded via lines 13, 14. It will be understood by persons skilled in the art that the machine control 12 can generate a signal in a conventional manner, which corresponds to the passage of the channel of the impression cylinder 1, through use of an angle transmitter 15 connected to the printing machine.

From the foregoing it can be seen that by reason of the method and apparatus of the present invention UV varnish can be applied directly onto sheets printed with conventional printing inks containing oils or the like without the necessity for additional printing processes which heretofore have increased the cost of printing machines. The method and apparatus furthermore are adapted for efficiently controlled operation.

What is claimed is:

12. A method of printing and coating printable material comprising the steps of:
initially printing the printable material with a printing ink in at least one printing process,
subjecting the printing ink on the printable material to a corona treatment after the at least one printing process to treat the surface for accepting a coating, and
thereafter coating the printing ink on the printable material in at least one coating process with a layer that covers the printing ink.

13. The method of claim 12 in which said corona treatment is carried out immediately after the printing process in a final printing station of a sheet-fed offset printing machine.

14. The method of claim 13 in which the corona treatment is carried out while the printable material is on a surface of an impression cylinder of the last printing station.

15. The method of claim 12 in which the corona treatment is effected as an incident to communication of a high voltage that is controlled as a function of a processing speed of the printable material.

16. The method of claim 12 in which the corona treatment is carried out by means of a rod-shaped electrode.

17. The method of claim 16 including effecting the corona treatment by applying a high voltage to the rod-shaped electrode which is controlled as a function of a processing speed of the printable material.

18. An apparatus for printing and coating printable material comprising:
a printing machine with a printing station for initially printing the printable material with a printing ink,
a device for carrying out a corona treatment on the printing ink applied to the printable material for conditioning the printing ink to accept a coating, and
a coating device arranged downstream of the printing station for coating the printable material with a layer that covers the printing ink after the printing ink has been subjected to the corona treatment.

19. The apparatus of claim 18 in which said device for carrying out a corona treatment is located between a final printing station of said printing machine and the device for coating the printable material.

20. The apparatus of claim 18 in which the device for carrying out the corona treatment is associated with an impression cylinder of the printing station.

21. The apparatus of claim 18 in which said device for carrying out the corona treatment includes an electrode in the form of a rod that extends across the width of the impression cylinder.

22. The apparatus of claim 18 in which the printing station is the final printing station of a sheet-fed offset printing machine, and said device for carrying out the corona treatment is associated with an impression cylinder of a final printing station of the printing machine.

23. The apparatus of claim 18 in which said coating device is a varnishing device for applying a varnish coating to the printable material.

24. The apparatus of claim 18 in which the device for carrying out the corona treatment is connected to a high voltage source, and a controller for controlling the high voltage source as a function of the speed at which printable material is processed through the printing machine.

25. The apparatus of claim 24 in which said controller controls the high voltage source to the device for carrying out the corona treatment as a function of an angular position of a cylinder of the printing machine that carries the printable material.
